(19) United States
(12) Patent Application Publication
(10) Pub. No.: US 2010/0306029 A1
(43) Pub. Date: Dec. 2, 2010

(54) Cardholder Clusters

(76) Inventor: Ryan Jolley, San Mateo, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/537,566

(22) Filed: Aug. 7, 2009

Related U.S. Application Data
(60) Provisional application No. 61/182,806, filed on Jun. 1, 2009.

(51) Int. Cl. G06Q 10/00; G06N 5/02

(52) U.S. Cl. 705/10; 706/52

(57) ABSTRACT

A system and method of using transaction data for a population of account holders, such as credit card holders, is described. A frequency distribution input variable (Frd) and average amount distribution input variable (Avd) are calculated for each account and each merchant category. The Frd and Avd, either alone or in conjunction with each other, are used to assign accounts to clusters as well as calculate factors for factor analysis. The assigned cluster and calculated factors for each account are both used for further processing, such for as selecting accounts to which advertising materials will be sent or determining a surrogate account for a control group.

### CROSS REFERENCES TO RELATED APPLICATIONS

This application is claims the benefit of U.S. Provisional Patent Application No. 61/182,806, filed Jun. 1, 2009; the entire disclosure of which is incorporated herein by reference.

### BACKGROUND

1. Field of the Invention

Systems and methods for summarizing and analyzing transaction data and subsequently using the summarized data to perform additional processing are disclosed. Specifically, methods for summarizing credit, debit, and other payment card and account transaction data and using the summarized data for internal analyses as well as target advertising are disclosed.

2. Discussion of the Related Art

In processing credit card, debit card, and other payment card and account transactions between customers and merchants, transaction data is accumulated by a card processing company. Such transaction data typically includes an entry or “transaction record” for each transaction. Each transaction record includes data corresponding to one transaction. The transaction record can include a date and time at which the transaction was made, a cardholder account identifier (i.e., an account number of a customer), a merchant identifier (i.e., a name and address of the merchant, a unique merchant number, or a categorical grouping), the geographic location (e.g. the city or zip code) of the transaction, and the amount of the transaction and whether it was a debit or credit. Other data can also be recorded, such as the channel type of the transaction (i.e. whether the transaction was made online, by phone, or offline) or whether there was a currency conversion.

Although indicated as “card” transactions, card transactions described herein can take place without a physical card. A card can assume forms other than a physical card, such as a virtual card or number indicating an account. Likewise, “cardholders” may not own a card but may simply have access to or be authorized to use the virtual card or number indicating an account.

A card holder or other account holder can be a natural person, business entity, or any other organization which is associated with using the account to cause transactions and make payments on the account.

Millions of payment card transactions occur daily. Their corresponding records are recorded in databases for settlement, financial recordkeeping, and government regulation. Naturally, such data can be mined and analyzed for trends, statistics, and other analyses. Sometimes such data is mined for specific advertising goals, such as to target coupon mailings or other advertisements to account holders that are more likely to spend on the advertised products or services.

However, the sheer volume of card transaction records and the number of fields collected for each record poses a problem. Transaction data in its raw form can be cumbersome for certain analyses or for projects on shortened timelines. Even with very fast computers and processors, it can be difficult to manipulate the transaction data so that it is meaningful, understandable, and intuitive for human users.

### BRIEF SUMMARY

Embodiments in accordance with the present disclosure relate to processing account transaction data to ascertain statistical clusters in the data as well as produce factors which may be suitable for factor analysis. The clusters and factors are then both used for further processing, such as for selecting accounts. The accounts selections can be suitable for targeted advertising, fraud prevention, bankruptcy protection, surrogate accounts, and other useful purposes.

Some embodiments process the raw transaction data to produce a “frequency distribution input variable (Frd)” and an “average amount distribution input variable (Avd)” for each account. The frequency distribution input variable, Frd_{a,MCC}, can be the number of times a transaction occurs in account a at a merchant category code (MCC) over an amount of time. It may be relative to and normalized with the total population for that merchant category. The average amount distribution input variable, Avd_{a,MCC}, can be the average amount spent by account a in merchant category MCC. It can be relative to and normalized with the total population for that merchant category.

A merchant category code MCC can mean a category of several merchants or can be more granular to include a different category for each merchant. In the latter case, the MCC is more of a specific merchant identifier as opposed to a category. MCC herein refers to both merchant identifiers and merchant categories. For example, an MCC can be “Gasoline Station” in order to refer to the merchant category of gasoline stations. As another example, an MCC can be “Shell Station No. A1421” in order to refer to a particular gasoline station at a particular location.

One embodiment in accordance with the present disclosure relates to a computer-implemented method of using transaction data for a population of account holders having accounts. The method includes receiving a frequency distribution input variable (Frd) for each account in each merchant identifier based on the transaction data and receiving an average amount distribution input variable (Avd) for each account in each merchant identifier based on the transaction data. The method further includes assigning each account to a statistical cluster using at least one of the frequency distribution input variable Frd and the average amount distribution input variable Avd, calculating, using a processor, a factor for each account using at least one of the frequency distribution input variable Frd and the average amount distribution input variable Avd, and performing further processing of an account based on the cluster to which the account is assigned and based on the calculated factor for the account.

Further processing can include the selection of accounts. An embodiment can send an advertisement to the selected account, correlate two accounts to determine a surrogate account, or predict the gender and other demographic information of an account holder. It is common for transaction and account data not to include the gender of the account holder.

Other embodiments relate to systems and machine-readable tangible storage media which employ or store instructions for the methods described above.

A further understanding of the nature and the advantages of the embodiments disclosed and suggested herein may be realized by reference to the remaining portions of the specification and the attached drawings.

### BRIEF DESCRIPTION OF THE DRAWINGS

FIG. 1 illustrates processing transaction data to yield a result in accordance with an embodiment.

FIG. 2 illustrates the transaction data of FIG. 1 in flat file tabular format.

FIG. 3 illustrates a phase of processing of FIG. 1.

FIG. 4 is a histogram of frequency distribution input variables, Frd_{a,MCC,} over a population of accounts in accordance with an embodiment.

FIG. 5 is a histogram of average spend distribution input variables, Avd_{a,MCC,} over a population of accounts in accordance with an embodiment.

FIG. 6 illustrates a simplified view of clustering using two dimensions.

FIG. 7 is a partial table of cluster definitions, in accordance with an embodiment.

FIG. 8 is a partial table of dominant loading variables for factors, in accordance with an embodiment.

FIG. 9 is a diagram of selected accounts in accordance with an embodiment.

FIG. 10 is a flowchart illustrating an embodiment in accordance with an embodiment.

FIG. 11 shows a block diagram of a system that can be used in some embodiments.

FIG. 12 shows a block diagram of an exemplary computer apparatus that can be used in some embodiments.

The figures will now be used to illustrate different embodiments in accordance with the invention. The figures are specific examples of embodiments and should not be interpreted as limiting embodiments, but rather exemplary forms and procedures.

### DETAILED DESCRIPTION

A computer-implemented method of using transaction data for a population of account holders, such as credit card holders, is described. A merchant category code (MCC) or merchant identifier is paired to each transaction for each account.

A “frequency distribution input variable” (Frd) based on account transaction data is calculated or received for each account and merchant identifier. The single number scalar elements of Frd can be labeled Frd_{a,MCC,} in which “a” is an account and “MCC” is a merchant identifier. An account can be an account for a credit card, debit card, non-card identifier, or other account from which transactions can be realized. Frd can be unitless (i.e. just a number), but it inherently has units of frequency (number per unit of time) because the transaction data is for a fixed period of time. An example of an Frd is Frd_{1,MCC=Airlines}=6/year, meaning that account number 1 spent money on 6 different occasions with airlines during the past year. Frd can also be normalized with respect to other accounts, such as shown in Eqn. 1 (below). An example of such an Frd is Frd_{1,MCC=Airlines}=−0.40, the negative sign meaning that account number 1 spent money on fewer occasions than the average account holder in the population with airlines during the past year. Various scales can be used for the normalized variables.

An “average amount distribution input variable” (Avd) based on the transaction data is calculated or received for each account in each merchant category code or merchant identifier. Each single number scalar element of Avd can be labeled Avd_{a, MCC}. Preferably, Avd has units of currency, such as U.S. dollars. An example of an Avd is Avd_{a,MCC}=$199.95, meaning that account number 1 spent an average of $199.95 in each transaction with Airlines during the past year. Avd can also be normalized with respect to other accounts, such as shown in Eqn. 2 (below). An example of such an Avd is Avd_{1,MCC=Airlines}=+0.60, the positive sign meaning that account number 1 spent more in each transaction than the population average with airlines during the past year. Various scales can be used for the normalized variable.

Each account, which has an Frd for each MCC and an Avd for each MCC, is then assigned to a statistical “cluster” using either the Frd's, Avd's, or both. The clusters have been predefined using either the received transaction data or other transaction data. Clustering of data is a multivariate technique that organizes variables. An example of a cluster is an “Internet Loyalist” cluster, in which accounts that spend frequently and relatively large average amounts on computer network information services, computers, etc. are typically assigned. Other types of clusters may be assigned other labels, including “Wholesale Club Enthusiast,” “Family Provider,” “Avid Reader,” etc. In some embodiments, the labels of the clusters may be descriptive of the persons associated with the clustered set of accounts.

“Factors” are also calculated for each account using either the Frd's, Avd's, or both. The variables and weightings of the variables that go into the factors are predetermined. An example of a factor is a “Travel” factor, which reflects how much a person spends on parking lots and garages, lodging, and other travel-related expenses using a particular account. A person with a high travel factor may spend a lot at garages, but may not spend a lot on nurseries.

Further processing is then performed on an account based on both the cluster to which the account is assigned and based upon the calculated factor. The cluster and factors are both used in the processing. For example, accounts from a particular cluster which also have a high score for certain factors are selected for marketing materials. As another example, all accounts from a particular cluster as well as accounts from other clusters with high scores for certain factors are selected. As another example, an account is associated with a second account in the same cluster and that has similar factor scores. As yet another example, the cluster to which an account is assigned and certain factors are used to predict the gender or other demographic information of the account holder such as account holder's income, the presence of children, etc.

Before describing broader embodiments in detail, examples will be described of some embodiments.

### EXAMPLE 1

In this example of an embodiment, account transaction data for thousands of accounts is processed. The transaction data is for transactions occurring over a 12-month period. The exemplary transaction data is in one table, otherwise known as a flat file database, sorted by date and time.

The merchants with which the accounts transacted are categorized into 40 categories of merchants. For example, merchants such as Arco, Exxon Mobil, and Texaco gas station franchises are categorized as Gasoline merchants and given a corresponding merchant category code. For each transaction, a merchant category code is listed in the transaction data. Likewise, merchants such as as J.C. Penney, Macy's, and Nordstrom stores are categorized as Department Stores.

The transaction data is sorted and separated into different accounts. For each account, two input variables are calculated from the data for each merchant category: (1) frequency distribution input variable (Frd), and (2) average amount distribution input variable (Avd). Because there are 40 merchant categories, 80 input variables are calculated for each account: Frd_{a,MCC=1..40} and Avd_{a, MCC=1..40}.

Each account is assigned to one of 17 clusters of accounts based on the account's Frd's and Avd's. The number and types of clusters of accounts have been predetermined using statistical clustering methods. Names have been assigned to the predetermined clusters to aid in human interpretation of the data. For example, an account with high Frd's and Avd's for Computer Network Information Services and similar merchants is assigned to an “Internet Loyalist” cluster. As another example, an account with high Frd's for Discount Stores and low Avd's for restaurants is assigned to a “Just the Essentials” cluster.

Each account is given 12 factors, which are calculated for each account based on the account's Frd's and Avd's. The number and types of factors have been predetermined using factor analysis methods. For example, an “Average Ticket Amt” factor is calculated using the Avd for each merchant category in the account. If the Average Ticket Amt factor is large, then it means that the account holder typically spends more than most people in many merchant categories. As another example, an “E-commerce/Electronics” factor is calculated using the Frd and Avd input variables. If there is a high Frd at Electronic Stores and Record Stores, then the E-commerce/Electronics factor is high.

Consider the situation in which an electronics vendor is going to hold a lavish, invitation-only social gathering at a luxury hotel to demonstrate its new, high end video game controllers. Because of the expense of the gathering, the vendor wishes to invite only those who are both into high end video games and who are likely to shell out top dollar for a top-of-the-line game controller. To select invitees, the vendor picks cardholders in the Internet Loyalist cluster for its initial pool and then narrows down the selection by only picking those with an Average Ticket Amt factor that is far above average and an E-commerce/Electronics factor that is above average. In this way, the vendor quickly narrows down the data to one of the 17 clusters, and then focuses its search on a small number of factors.

### EXAMPLE 2

As another example, the same account transaction data is processed as in Example 1, assigning each account to one of the 17 clusters and calculating 12 factors for each account. In this Example, advertisements for a new soda have already been sent to ten-thousand account holders. The vendor wishes to determine the effectiveness of the marketing materials by comparing people to whom the advertising materials were sent with similar people to whom the materials were not sent. Essentially, the vendor wishes to determine a quasi-control group.

For each account holder a1 to whom advertisements were sent, the assigned cluster and 12 factors are determined. Then, a second account holder a2 is determined who is in the same cluster as a1 and has 10 of 12 factors within a range of ±5% of the factors of a1. Once the account holder a2 is determined, a2 can be labeled the “surrogate account” of account holder a1. Whether and to what extent a1 purchased more soda than a2 is quantified, and the results are aggregated. In this way, the effect of advertising materials is more precisely measured because each target person in the advertising campaign is compared with a statistically similar person.

These examples are for illustrative purposes only and show the value in processing the transaction data in the specific methods shown.

### DISCUSSION OF FIGURES

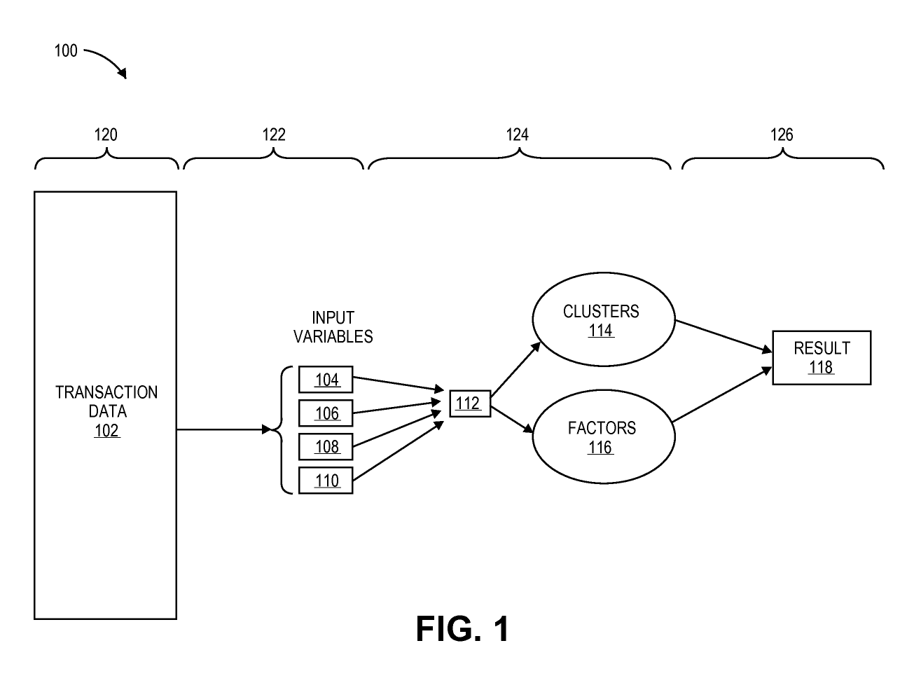

FIG. 1 illustrates the processing of a transaction data to yield a result in accordance with an embodiment. Process 100 begins with the step 120 of receiving transaction data 102. Step 122 includes receiving input variables for the accounts calculated from transaction data 102. In step 124, input variables 104, 106, 108, and 110 fed into summary algorithms 112 which are used to assign each account to a cluster in clusters 114 and calculate factors 116 for each account. In step 126, both clusters 114 and factors 116 are used to produce a result 118.

The assignment of clusters to some accounts can occur at the same time as other account data is being loaded or received. Similarly, factors can be calculated for some accounts while others are being loaded or received. One skilled in the art would recognize that certain steps can be performed before, concurrently with, or after other steps.

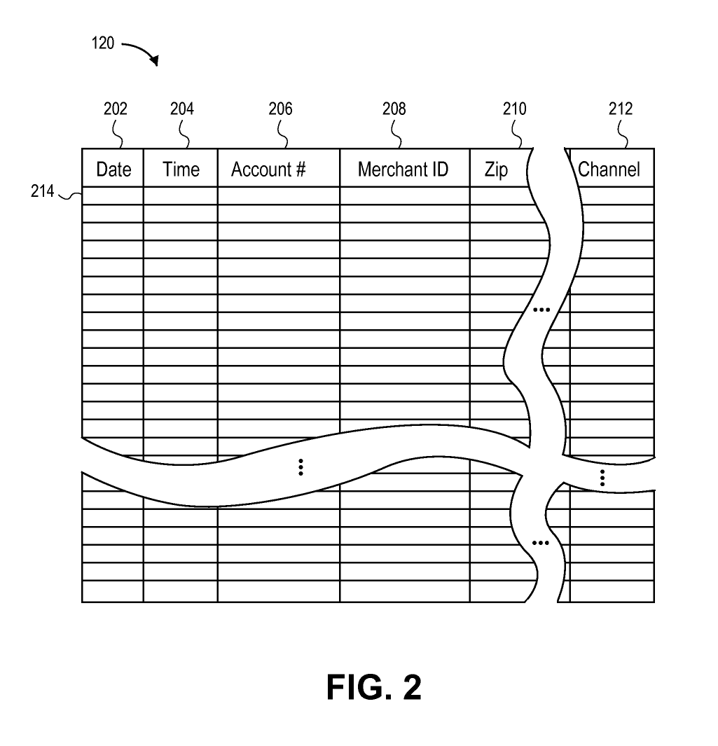

FIG. 2 illustrates transaction data 120 in a flat file configuration. Transaction data 120 includes fields or columns 202, 204, 206, 208, 210, and 212 indicating the date, time, account number, merchant identifier, zip code where the transaction was initiated, and the channel type (i.e. online, phone, offline) of the transaction. A transaction entry or record 214 is shown as a row in the figure.

Transaction data can be in other formats, for example relational database formats. A single purchase for an account holder can be broken into multiple transactions in the data. For example, the purchase of non-food items at a grocery store can be separated into a separate transaction than the purchase of food items. Similarly, multiple purchases can be aggregated into one transaction in the data. For example, monthly phone bill payments can be aggregated into one transaction.

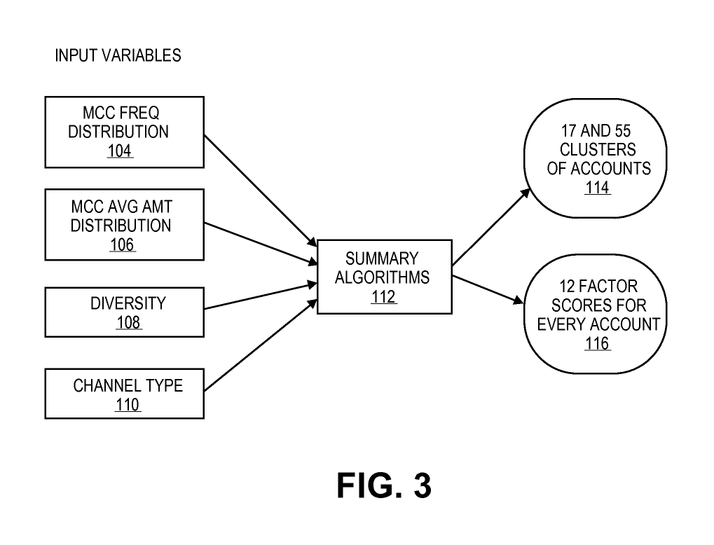

FIG. 3 illustrates a phase of processing of FIG. 1. Input variables include Merchant Category Code (MCC) frequency distribution Frd 104, MCC average amount distribution Avd 106, diversity 108, and channel type 110. The input variables are fed into summary algorithms 112, which determine the assignment of each account in the transaction data to one of 17 clusters 114 and also calculate 12 factor scores 116 for each account.

a) Input Variable Creation—Method 1

To calculate Frd, the following equation can be used:

$${Frd}_{a , MCC} = \frac{\begin{matrix}{frq\_acct}_{a , MCC} - \\ tot\_tran {\_cnt}_{a} * {dist\_pop}_{MCC}\end{matrix}}{\sqrt{\begin{matrix}tot\_tran {\_cnt}_{a} * {dist\_pop}_{MCC} * \\ ( 1 - {dist\_pop}_{MCC} )\end{matrix}}} \qquad Eqn 1$$

in which:

Frd_{a,MCC} is the frequency distribution input variable for account a in merchant category MCC;

frq_acct_{a,MCC} is a total number of transactions for account a in merchant category MCC;

tot_tran_cntₐ is a total number of transactions for the account; and dist_pop_{MCC} is a percent of transactions for the population at merchant category MCC

To calculate Avd, the following equation can be used:

$${Avd}_{a , MCC} = \frac{{avg\_acct}_{a , MCC} - {avg\_pop}_{MCC}}{\sqrt{avg\_std / mcc\_acct {\_cnt}_{a , MCC}}} \qquad Eqn . 2$$

in which:

AVd_{a,MCC} is the average amount distribution input variable for account a in merchant category MCC;

avg_acct_{a,MCC} is an average amount spent by account a in merchant category MCC;

avg_pop_{MCC} is an average spent by the population at merchant category MCC;

avg_std is the standard deviation of the average amount spent for the population; and

mcc_acct_cnt_{a,MCC} is a total number of transactions for account a in merchant category MCC.

The Frd and Avd input variables can be constrained to eliminate extreme outliers. For example, for Frd varables the minimum value can be constrained to be (value at 1%-tile)−median−(value at 1%-tile)*0.1. The maximum value can be constrained to be (value at 99%-tile)+(value at 99%-tile−median)*0.1. For Avd variables, the minimum value can be constrained to be min(1%-tile, −3). The maximum value can be constrained to be max(99%-tile, 3). Avd can be set to 0 if there are no transactions for the account/MCC.

Input Variable Creation—Method 2

An alternate method of creating input variables is as follows. One begins with raw optimized settled transaction data for a 12-month period. Accounts are removed that do not meet activity, diversity, and consistency criteria. That is, accounts are removed that have less than 20 transactions, less than 5 distinct merchant category codes (MCC's), and no transaction in the beginning month and ending month. Recurring transactions or MCC's that are associated with recurring behavior are identified. An example of recurring transactions is automatic bill payments of a phone bill. In effect, the account holder has made one decision to pay, but payments to that effect are realized over the course of several months in discrete transactions. The total amounts of such recurring payments are aggregated by the unique account number, MCC, merchant normalized ID, and an ECI moto code. The recurring payments are treated as one transaction record (i.e. transaction count=1).

The accounts are matched to a North American Industry Classification System (NAICS) codes by using the merchant normalized ID. The accounts are matched to NAICS codes by the MCC if no NAICS is found in the previous step. A random sample is then taken for development.

An appropriate model is developed to calculate the expectation of frequency and spend variables. One variable is selected from each of the tables below:

TABLE 1
Frequency Variable Type

| Variable | | |
|---|---|---|
| Name | Observed | Expected |
| Ind | 2 possible values (0, 1). 0 | Logistic regression model |
| | if no occurrence; 1 if at least | with independent variable |
| | one transaction at specified | MCC count and Observed as |
| | NAICS | dependent variable |
| Frd | Number of transactions at | Poisson regression model with |
| | NAICS | natural log of total transaction |
| | | count as independent variable |
| | | and Observed as dependent |
| | | variable |

TABLE 2
Spend Variable Type

| Variable | | |
|---|---|---|
| Name | Observed | Expected |
| Avd | Total transaction amount | Linear regression model with |
| | for that NAICS. If no | total number of transactions for |
| | transaction in that NAICS, | that NAICS as independent |
| | set to 0 | variable and Observed as |
| | | dependent variable - no |
| | | intercept |
| Tvd | Total transaction amount | Linear regression model with |
| | for that NAICS. If no | SQRT (total transaction amount |
| | transaction in that NAICS, | across all NAICS) as |
| | set to 0 | independent variable and |
| | | Observed as dependent |
| | | variable |

Observed and Expected variables are calculated for each account and all NAICS in the development sample. Thus, in the exemplary embodiment, each NAICS will have all 4 variables in the tables above calculated for development.

The value for each variable is (Observed-Expected), with the following conditions. First, the variance is set equal to the percent of accounts that shop at that NAICS. This forces the variable to be equal to the ‘importance’ of the variable. Second, each NAICS is set to a lower bound of a 1st percentile and an upper bound of a 99th percentile.

To develop the clusters and factors, only 1 frequency variable and 1 spend variable are used with each NAICS in the exemplary embodiment. The Frd variable may not generally be used with the Tvd variable. Thus, possible frequency/spend variable combinations for each NAICS are (Frd, Avd), (Ind, Avd), and (Ind, Tvd).

To find the optimal frequency/spend variable combination for each NAICS, the following process can be followed. All the variables are initialized for each NAICS. If a NAICS code is associated with a high occurrence of recurring transactions, then the corresponding variables types are (Ind, Tvd). If the percentage of occurrence for NAICS>threshold (e.g. 35%), then the corresponding variable types are (Frd, Avd). Otherwise, set the variable types to (Ind, Avd).

A factor analysis is run (i.e. the principal component method with a covariance matrix), and pertinent information is captured, given the number of factors retained. Information captured is the percent of variance explained by the factors retained (pct_var), Deviance=(variable variance)*(Communality−pct_var), and Deviance2=Deviance ̂ 2.

All the other variable combinations of NAICS are tested in the order of ascending Deviance.

For each NAICS, the two other variable sets that can be used are calculated.

These steps are looped for all NAICS categories. If any of the two new variable sets for each NAICS give a higher pct_var and higher deviance2 compared to the old variable set, then the old variable set is replaced with the new variable set. This process has been found to yield good results. This concludes the description of method 2 of input variable creation. Other methods can be used instead of or to supplement those described herein to develop the appropriate model and input variables.

After the appropriate model is developed, different variable iterations for each NAICS are tested. The low value NAICS variables are combined, and a test is run to determine if it can be combined into the closest NAICS.

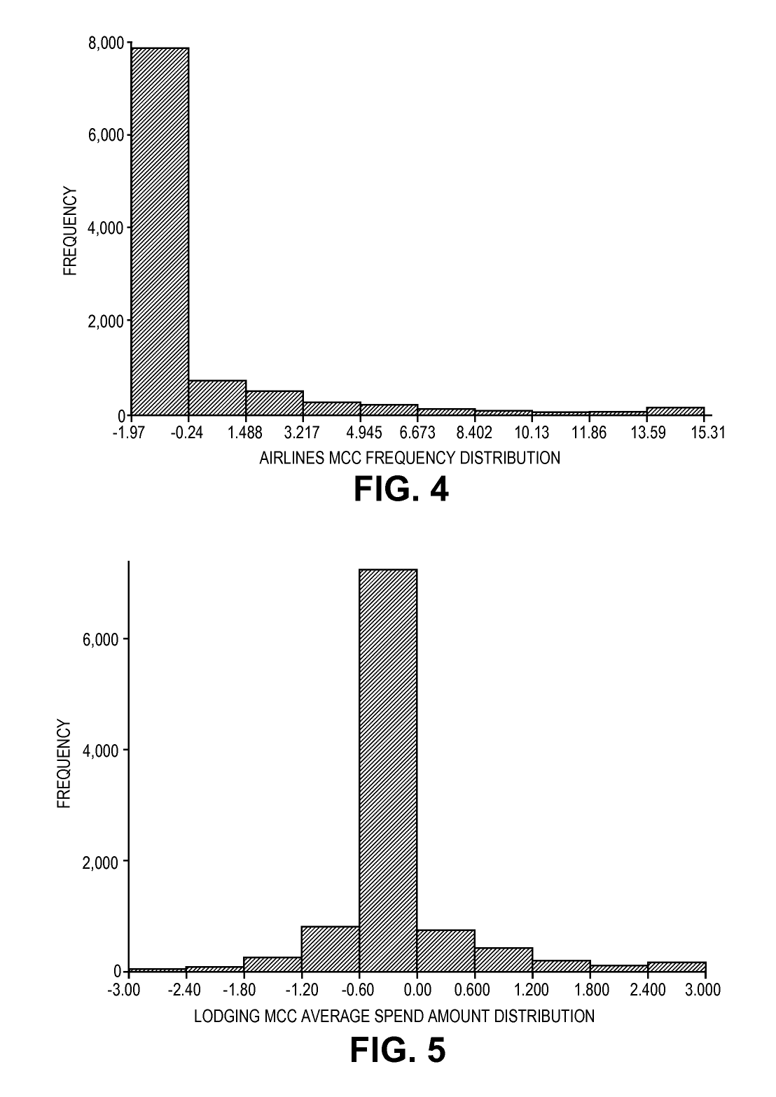

FIG. 4 is a histogram of frequency distribution input variables, Frd_{a,MCC}, over a population of accounts for MCC=Airlines. The frequency distribution Frd variables generally show the significance of the number of transactions at each merchant category by account number, adjusted by the total number of transactions for that account. The high skewness of the data, as shown in the figure, is common for many Frd variables. Negative values imply a lower than average occurrence of transactions for that MCC given the total number of transactions for that account.

FIG. 5 is a histogram of average spend distribution input variables, Avd_{a,MCC}, over a population of accounts for MCC=Lodging. The average spend Avd variable generally show the significance of the average spend at each account/MCC combination, adjusted by the total of transactions for that account/MCC. The high kurtosis of the data, as shown in the figure, is common to many Avd variables. If there are no transactions at that account/MCC combination, then the value for Avd is set to 0.

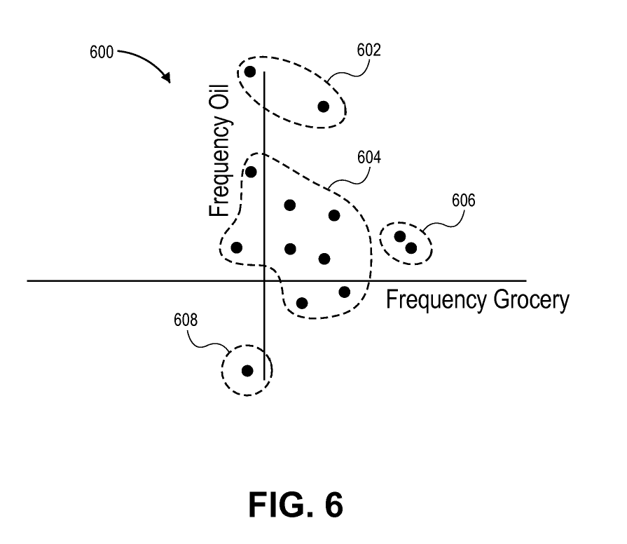

FIG. 6 illustrates a simplified view of statistical clustering. Cluster analysis of transactional data generally attempts to group accounts together that have similar transactional behavioral spending patterns. One of the goals is to create natural groupings of accounts which have similar spending patters within a cluster, yet simultaneously maximize differences in spending patterns across clusters. The figure shows four cluster groupings in chart 600 based on two dimensions, Frd_{a,MCC=Oil} and Frd_{a,MCC=Grocery}. The data points shown each represent one account. The two accounts in cluster 602 are grouped or clustered together. The accounts assigned to one cluster are preferably not assigned to other clusters.

Cluster analysis can be performed by several statistical methods. Data points are organized into relatively homogeneous groups or clusters. The clusters are internally homogeneous such that members are similar to one another and externally heterogeneous such that members are not like members of other clusters. In the figure, the accounts of cluster 602 are similar to one another but unlike the accounts in clusters 604, 606, and 608.

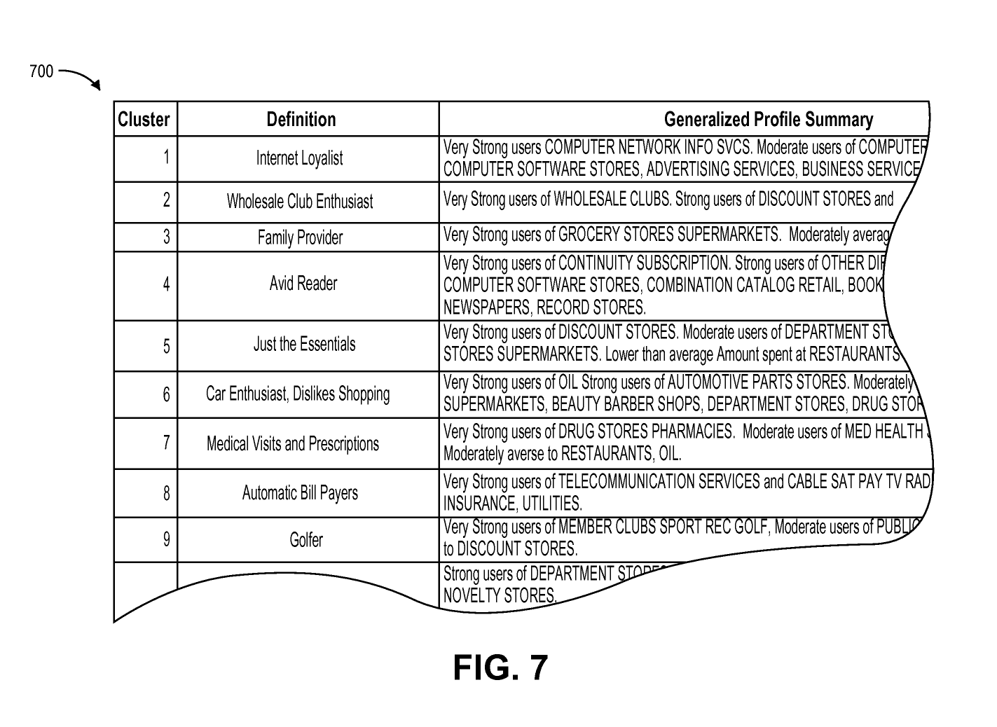

FIG. 7 is a partial table of cluster definitions, in accordance with an embodiment. Table 700 includes names of some of the clusters, including “Internet Loyalist,” “Wholesale Club Enthusiast,” and “Family Provider.” The summary column for each cluster includes the cluster's relation to salient merchant categories. For example, the Internet Loyalist cluster generally has very strong users of Computer Network Information Services as well as moderate users of Computer Software Stores, Advertising Services, and Business Services.

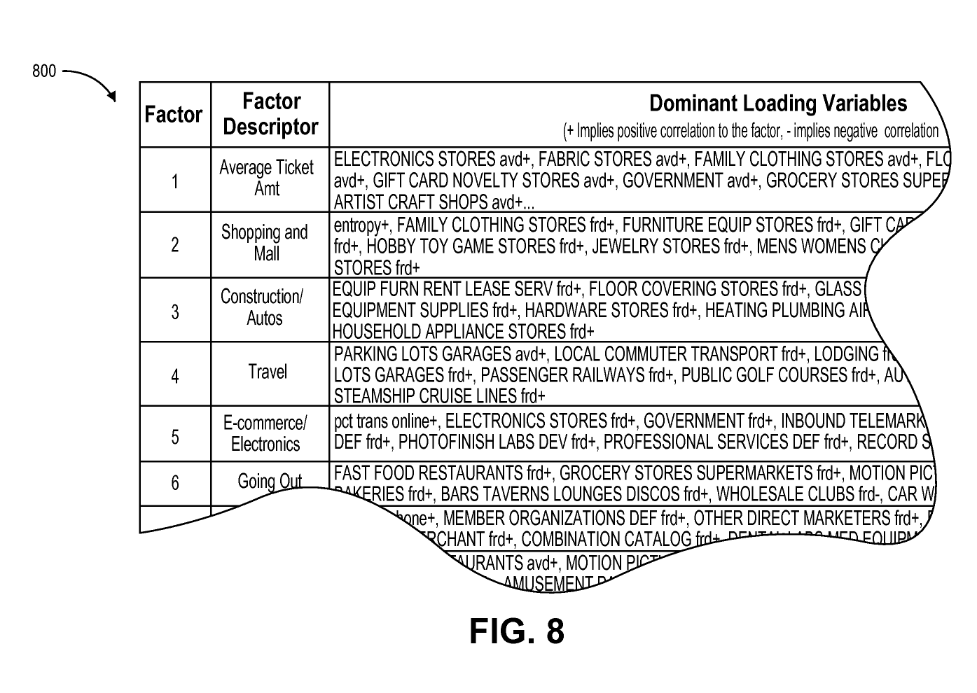

FIG. 8 is a partial table of factors, in accordance with an embodiment. Table 800 includes names of some of the factors, including “Average Ticket Amt,” “Shopping and Mall,” and “Construction/Autos.” The dominant loading variables column shows what input variables dominate or otherwise are highly correlated with each factor. For example, The Travel factor is positively correlated with Avd_{a,MCC=Parking Lot Garages} and Frd_{a,MCC=Local Commuter Transport}.

Other clusters and factors can be used. Allocations to 17 or 55 predefined clusters have been shown to be useful, along with 12 factors for each of the accounts. A greater or fewer number of clusters may suit different regions, times of the year, or account holder ages or other demographics. A greater or fewer number of factors may be analyzed for each account/MCC. A greater number of factors can offer higher resolution at the cost of more data to analyze while fewer factors offers less granularity with the savings of less data to analyze.

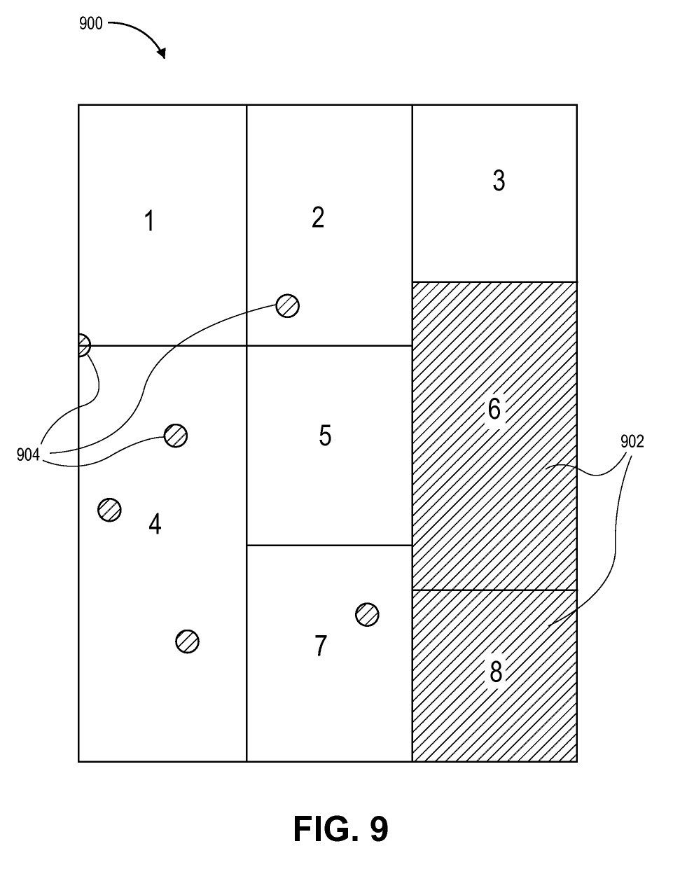

FIG. 9 is a diagram of selected accounts in accordance with an embodiment. A vendor may wish to target an audience within population 900 for an advertisement mailing. It may be straightforward to select clusters 902 because they are more closely related to the product than the other clusters. For example, an advertiser may wish to advertise a new business cell phone to those in the Internet Loyalist and Business Supplies clusters. However, there might not be enough people in those clusters to fully market the product. Therefore, factors can be analyzed for accounts in all or a subset of all of the other clusters to determine other account holders to which to advertise. For example, the new business cell phone may be perfectly marketable to anyone with a high E-commerce/Electronics factor. Various account holders 904 in other clusters may be just as likely to buy a vendor's product as those account holders in clusters 902.

By using both clusters and factors, a vendor can relatively quickly and flexibly select a target audience while spend its full marketing budget for the number of people it needs.

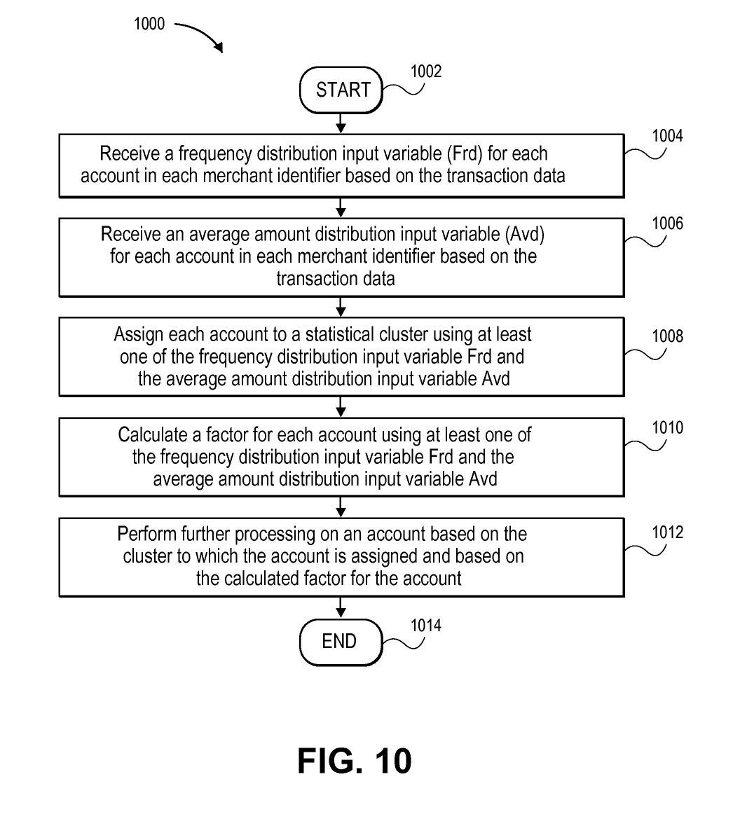

FIG. 10 shows an example flowchart illustrating process 1000 in accordance with one embodiment. This process can be automated in a computer or other machine. The process can be coded in software, firmware, or hard coded as machine-readable instructions and run through a processor that can implement the instructions. Operations start at operation 1002. In operation 1004, a frequency distribution input variable (Frd) for each account in each merchant identifier based on the transaction data is received. In operation 1006, an average amount distribution input variable (Avd) for each account in each merchant identifier based on the transaction data is received. In operation 1008, each account is assigned to a statistical sluster using at least one of the frequency distribution input variable Frd and the average amount distribution input variable Avd. In operation 1010, at least one factor is calculated for each account using at least one of the frequency distribution input variable Frd and the average amount distribution input variable Avd. In operation 1012, further processing is performed on an account based on the cluster to which the account is assigned and also based on the calculated factor for the account. The exemplary embodiment ends at operation 1014. These operations may be performed in the sequence given above or in different orders as applicable.

Obtaining Transaction Data

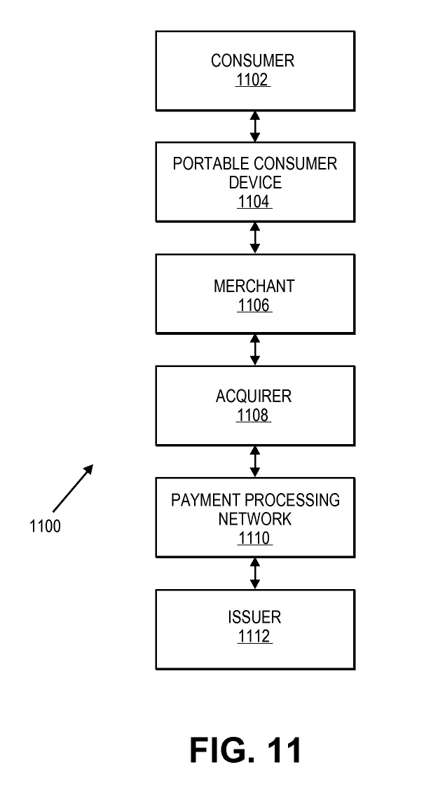

The transaction data can be obtained in any suitable manner. The transaction data can be generated using the system shown in FIG. 11. FIG. 11 shows a system 1100 that can be used in an embodiment of the invention. The system 1100 includes a merchant 1106 and an acquirer 1108 associated with the merchant 1106. In a typical payment transaction, a consumer 1102 may purchase goods or services at the merchant 1106 using a portable consumer device 1104. The acquirer 1108 can communicate with an issuer 1112 via a payment processing network 1110.

The consumer 1102 may be an individual, or an organization such as a business that is capable of purchasing goods or services.

The portable consumer device 1104 may be in any suitable form. For example, suitable portable consumer devices can be hand-held and compact so that they can fit into a consumer's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

The payment processing network 1110 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The payment processing network 1110 may include a server computer. A server computer is typically a powerful computer or cluster of computers. For example, the server computer can be a large mainframe, a minicomputer cluster, or a group of servers functioning as a unit. In one example, the server computer may be a database server coupled to a Web server. The payment processing network 1110 may use any suitable wired or wireless network, including the Internet.

The merchant 1106 may also have, or may receive communications from, an access device that can interact with the portable consumer device 1104. The access devices according to embodiments of the invention can be in any suitable form. Examples of access devices include point of sale (POS) devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like.

If the access device is a point of sale terminal, any suitable point of sale terminal may be used including card readers. The card readers may include any suitable contact or contactless mode of operation. For example, exemplary card readers can include RF (radio frequency) antennas, magnetic stripe readers, etc. to interact with the portable consumer devices 1104.

In a typical purchase transaction, the consumer 1102 purchases a good or service at the merchant 1106 using a portable consumer device 1104 such as a credit card. The consumer's portable consumer device 1104 can interact with an access device such as a POS (point of sale) terminal at the merchant 1106. For example, the consumer 1102 may take a credit card and may swipe it through an appropriate slot in the POS terminal. Alternatively, the POS terminal may be a contactless reader, and the portable consumer device 1104 may be a contactless device such as a contactless card.

An authorization request message is then forwarded to the acquirer 1108. After receiving the authorization request message, the authorization request message is then sent to the payment processing network 1110. The payment processing network 1110 then forwards the authorization request message to the issuer 1112 of the portable consumer device 1104.

After the issuer 1112 receives the authorization request message, the issuer 1112 sends an authorization response message back to the payment processing network 1110 to indicate whether or not the current transaction is authorized (or not authorized). The transaction processing system 1110 then forwards the authorization response message back to the acquirer 1108. The acquirer 1108 then sends the response message back to the merchant 1106.

After the merchant 1106 receives the authorization response message, the access device at the merchant 1106 may then provide the authorization response message for the consumer 1102. The response message may be displayed by the POS terminal, or may be printed out on a receipt.

At the end of the day, a normal clearing and settlement process can be conducted by the transaction processing system 1110. A clearing process is a process of exchanging financial details between and acquirer and an issuer to facilitate posting to a consumer's account and reconciliation of the consumer's settlement position. Clearing and settlement can occur simultaneously.

The transaction data can be captured by the payment processing network 1110 and a computer apparatus in the payment processing network (or other location) may process the transaction data as described in this application. The captured transaction data can include data including, but not limited to: the amount of a purchase, the merchant identifier, the location of the purchase, whether the purchase is a card-present or card-not-present purchase, etc.

The various participants and elements in FIG. 11 may operate one or more computer apparatuses to facilitate the functions described herein. Any of the elements in FIG. 11 may use any suitable number of subsystems to facilitate the functions described herein. Further, the computer apparatus can be used to assign accounts to clusters, provide factor scores for accounts, and perform any other processing described.

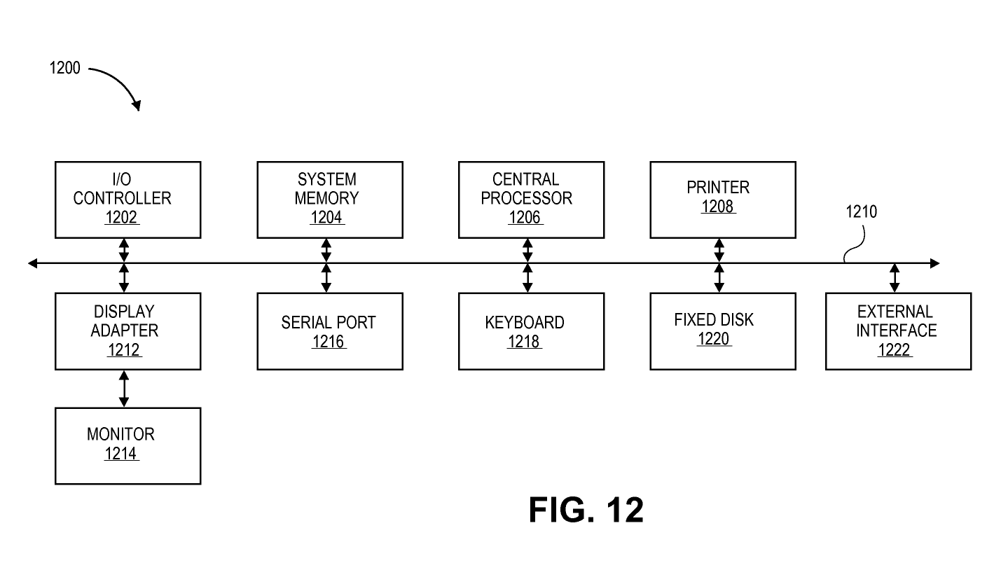

Examples of such subsystems or components are shown in FIG. 12. The subsystems shown in FIG. 12 are interconnected via a system bus 1210. Additional subsystems such as a printer 1208, keyboard 1218, fixed disk 1220 (or other memory comprising computer readable media), monitor 1214, which is coupled to display adapter 1212, and others are shown. Peripherals and input/output (I/O) devices, which couple to I/O controller 1202, can be connected to the computer system by any number of means known in the art, such as serial port 1216. For example, serial port 1216 or external interface 1222 can be used to connect the computer apparatus to a wide area network such as the Internet, a mouse input device, or a scanner. The interconnection via system bus allows the central processor 1206 to communicate with each subsystem and to control the execution of instructions from system memory 1204 or the fixed disk 1220, as well as the exchange of information between subsystems. The system memory 1204 and/or the fixed disk 1220 may embody a tangible computer readable medium.

Embodiments of the invention have a number of advantages. For example, as illustrated in FIG. 1, clusters and factors can be formed using a single set of transaction data, and the clusters and factors can be used to provide a result that is particularly useful in predicting events or situations such as whether or not marketing might be particularly effective for a particular individual or a particular class of individuals. The transaction data can be limited in size, and the prediction methods and systems according to embodiments of the invention can be applied to a larger number of accounts that may be used to generate other transaction data. As another example, cluster and factors used together in combination can better predict what people would be more interested in a particular product being advertised than just using clusters or just using factors alone. This can overcome problems with using only one method. Using clustering alone, there is not much granularity in the data. Using factors alone is less intuitive and may be overly sensitive to normalization. In an embodiment, choosing a cluster to target can be more like a course selection, then using factors can lead to finer selections. In another example, as illustrated in FIG. 9, clusters and factors can be used to expand a target audience from people in just one or two clusters. This allows a marketing campaign to ‘spend its budget’ on a precise number of people, rather than spend to however many people are in a cluster. As another example, clusters and factors can be used to select a shadow or surrogate person of a person who has already received marketing materials or been targeted already. This allows a control group to be formed after advertising has already been initiated. For yet another example, clusters and factors can be used to predict the gender or other demographic information of an account holder or card user. The gender of the account holder is often unknown to card processing companies. First names of cardholders often do not predict the gender of a the account holder very well, especially in the case of foreign, exotic, and unique names. Furthermore, the card may be issued to one family member, but another family member might do all the shopping with it. Clusters and factors can be used, either alone or in conjunction with other data, to ascertain the gender of the person spending. Other demographic information can be determined, such as income, the presence of children, etc. Many other advantages not described here can be realized with embodiments of the invention.

Changes of time in factors and the cluster to which an account is assigned can also be used. For example, a sudden shift from one cluster to another cluster, along with shifts in factors, can indicate that a card has been stolen and/or that the legal account holder's identity has been stolen. Slower shifts, such as from a Family Provider cluster, to Wholesale Club Enthusiast, to Just the Essentials clusters, along with lowering of factors in overall spending and “Going Out” spending, can indicate a possible slide into bankruptcy. Other changes in cluster and factor calculations over time may indicate other problems.

Embodiments of the invention are not limited to the above-described embodiments. For example, although separate functional blocks are shown for an issuer, payment processing network, and acquirer, some entities perform all of these functions and may be included in embodiments of invention.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A computer-implemented method of using transaction data for a population of account holders having accounts, the method comprising:
a) receiving a frequency distribution input variable (Frd) for each account in each merchant identifier based on the transaction data;
b) receiving an average amount distribution input variable (Avd) for each account in each merchant identifier based on the transaction data;
c) assigning each account to a statistical cluster using at least one of the frequency distribution input variable Frd and the average amount distribution input variable Avd;
d) calculating, using a processor, a factor for each account using at least one of the frequency distribution input variable Frd and the average amount distribution input variable Avd; and
e) performing further processing using the cluster and the factor.

2. The computer-implemented method of claim 1 wherein:
further processing comprises selecting an account, wherein the selected account is a surrogate account and selecting includes correlating two accounts based on the two accounts being assigned to the same cluster and based on factor analyses of factors associated with the two accounts.

3. The computer-implemented method of claim 1 wherein further processing comprises:
selecting an account using the cluster and the factor; and
sending an advertisement to the selected account.

4. The computer-implemented method of claim 1 wherein further processing includes predicting account holder demographic information selected from the group consisting of gender, income, and the presence of children.

5. The computer-implemented method of claim 1 further comprising:
normalizing the frequency distribution input variables (Frd's) and average amount distribution input variables (Avd's) to the transaction data for the population of account holders.

6. The computer-implemented method of claim 1 further comprising:
determining a diversity of purchases across merchant identifiers for each account based on the transaction data, wherein the assigning and calculating use the diversity of purchases.

7. The computer-implemented method of claim 1 further comprising:
gathering a percentage of transactions in a channel type for each account based on the transaction data.

8. The computer-implemented method of claim 1 further comprising:
receiving transaction data for the population of account holders, the data including a series of transactions for accounts, each transaction of the series of transactions associated with a merchant identifier.

9. The computer-implemented method of claim 8 wherein the merchant identifier is selected from the group consisting of a specific merchant identifier, a general merchant category class identifier, and a North American Industry Classification System (NAICS) code.

10. The computer-implemented method of claim 1 wherein steps a), b), c), d), and e) are performed in the order shown.

11. The computer-implemented method of claim 1 wherein steps a), b), c), d), and e) are performed using a processor.

12. The computer-implemented method of claim 1 wherein the creating the frequency distribution input variable (Frd) for each account uses the following equation:
Frd_{a,MCC}=(frq_acct_{a,MCC}−tot_tran_cntₐ*dist_pop_{MCC})÷SQRT(tot_tran_cntₐ*dist_pop_{MCC}*(1−dist_pop_{MCC}))
wherein:
Frd_{a,MCC} is the frequency distribution input variable for account a in merchant category MCC;
frq_acct_{a,MCC} is a total number of transactions for account a in merchant category MCC;
tot_tran_cntₐ is a total number of transactions for the account; and
dist_pop_{MCC} is a percent of transactions for the population at merchant category MCC.

13. The computer-implemented method of claim 1 wherein the creating the average amount distribution input variable (Avd) for each account uses the following equation:
Avd_{a,MCC}=(avg_acct_{a,MCC}−avg_pop_{MCC})÷SQRT(avg_std/mcc_acct—cnt_{a,MCC})
wherein:
Avd_{a,MCC} is the average amount distribution input variable for account a in merchant category MCC;
avg_acct_{a,MCC} is an average amount spent by account a in merchant category MCC;
avg_pop_{MCC} is an average spent by the population at merchant category MCC;
avg_std is the standard deviation of the average amount spent for the population; and
mcc_acct_cnt_{a,MCC} is a total number of transactions for account a in merchant category MCC.

14. The computer-implemented method of claim 13 wherein the merchant category MCC is defined by a North American Industry Classification System (NAICS).

15. A machine-readable tangible medium embodying information indicative of instructions for using one or more machines to perform operations to use transaction data for a population of account holders having accounts, the instructions comprising:
a) receiving a frequency distribution input variable (Frd) for each account in each merchant identifier based on the transaction data;
b) receiving an average amount distribution input variable (Avd) for each account in each merchant identifier based on the transaction data;
c) assigning each account to a statistical cluster using at least one of the frequency distribution input variable Frd and the average amount distribution input variable Avd;
d) calculating, using a processor, a factor for each account using at least one of the frequency distribution input variable Frd and the average amount distribution input variable Avd; and
e) performing further processing of an account using the cluster and the factor.

16. The machine-readable medium of claim 15 wherein performing further processing includes:
selecting an account, wherein the selected account is a surrogate account and the selecting includes correlating two accounts based on the two accounts being assigned to the same cluster and based on factor analyses of the factors of the two accounts.

17. The machine-readable medium of claim 15 wherein performing further processing includes:
selecting an account; and
sending an advertisement to the selected account.

18. The machine-readable medium of claim 15 wherein further processing includes predicting account holder demographic information selected from the group consisting of gender, income, and the presence of children.

19. The machine-readable medium of claim 15 wherein the instructions further comprise:
normalizing the frequency distribution input variables (Frd's) and average amount distribution input variables (Avd's) to the transaction data for the population of account holders.

20. The machine-readable medium of claim 15 wherein the instructions further comprise:
determining a diversity of purchases across merchant identifiers for each account based on the transaction data, wherein the assigning and calculating use the diversity of purchases.
